(19) United States
(12) Patent Application Publication
(10) Pub. No.: US 2005/0251492 A1
(43) Pub. Date: Nov. 10, 2005

(54) Method and arrangement for implementing transactions between a data processing unit and a data center remote therefrom

(76) Inventor: Gerrit Bleumer, Schildow (DE)

Correspondence Address: SCHIFF HARDIN, LLP;PATENT DEPARTMENT, 6600 SEARS TOWER, CHICAGO, IL, 60606-6473, US

(21) Appl. No.: 11/099,364

(22) Filed: Apr. 5, 2005

(30) Foreign Application Priority Data
Apr. 6, 2004 (DE) 102004017309.5-53

(51) Int. Cl. G06F 17/00

(52) U.S. Cl. 705/403

(57) ABSTRACT

In a method and a data center for implementation of at least a first transaction between a first data processing unit, in particular a franking machine, and a remote first data center, the first transaction is implemented in an implementation step via a communication connection between the first data processing unit and the first data center. In a specification step preceding the implementation step, a first item of transaction control information associated with the first data processing unit is provided by a first source, and; the first transaction is implemented in the implementation step dependent on the first item of transaction control information. In a specification step preceding the implementation step, a second item of transaction control information associated with the first data processing unit is provided by a second source. The first transaction is implemented in the implementation step dependent on the second item of transaction control information.

### BACKGROUND OF THE INVENTION

1. Field of the Invention

The present invention concerns a method for implementation of at least a first transaction between a first data processing unit, in particular a franking machine, and a remote first data center of the type wherein the first transaction is implemented in an implementation step via a communication connection between the first data processing unit and the first data center and wherein, in a first specification step preceding the implementation step, a first item of transaction control information associated with the first data processing unit is predetermined by a first source and the first transaction is implemented in the implementation step dependent on the first item of transaction control information. The present invention furthermore concerns a corresponding arrangement for implementation of such a method.

2. Description of the Prior Art

In a number of applications, transactions are implemented via a communication connection between a first data processing unit and a remote first data center. Transactions can occur in which the state of the data processing unit is modified. Such transactions, for example, can be transactions in which data are loaded into the first data processing unit or removed therefrom. There may also be transactions in which no state change of the data processing unit itself ensues. For example, data simply is read out from the data processing unit.

For example, in the field of franking machines it is known to load postage into the franking machine via a communication connection between the franking machine and a remote data center of a service provider, which is frequently the manufacturer of the franking machine. This postage then can be used by the franking machine to generate valid franking imprints that are accepted by a postal carrier. In variants of systems known as post-payment systems, the loading event is protocolled in the data center of the service provider and (normally) transmitted to a data center of the postal carrier at a later point in time. The postal carrier then directly deducts the loaded amount with regard to the user of the franking machine.

In these systems, for security reasons, a separate contract exists between the postal carrier and the user of the respective franking machine for each franking machine. Additionally, a separate master data set is held and maintained in the respective data center for the respective franking machine. This master data set, synchronized at regular intervals, normally contains a credit limit. This credit limit is predetermined by the postal carrier using specific criteria and typically establishes a maximum postage amount that can be loaded into the franking machine within a specific time span.

For each new transaction with a postage-loading event, the data center of the service provider verifies whether the predetermined maximum amount is exceeded with the requested amount and reacts dependent on the result of the check. Thus, for example, the loading event can be interrupted when the credit limit is exceeded. In other words, the credit limit thus represents a first item of transaction control information dependent on which the transaction is implemented.

In particular for owners of a number of franking machines such as, for example, larger businesses (possibly at different sites), the problem often exists that the transactions of the individual franking machines can be only decentrally monitored or influenced at the individual franking machines. A central monitoring or influencing is normally possible only with difficulty or only with a specific delay after the postal carrier issues an invoice.

### SUMMARY OF THE INVENTION

An object of the present invention is to provide a method and an arrangement of the type described above wherein the disadvantages cited above are avoided or minimized and, in particular, simple central monitoring or influencing of the transactions of one or more data processing units is enabled.

This object is achieved in accordance with the present invention wherein a simple, central monitoring or influencing of the transactions of one or more data processing units is enabled when, in a method of the type initially described, a second item of transaction control information associated with the first data processing unit is predetermined by a second source in a second specification step preceding the implementation step, and wherein the first transaction is implemented dependent on the second item of transaction control information.

For an owner of multiple, (if applicable) decentrally-arranged first data processing units, it is thus possible in a simple manner to promptly monitor or influence the transactions of the first data processing unit as a second source or via a second source without the owner having to directly access the respective first data processing unit. In the case of a franking machine, for example, internal limits for the downloading of postage that deviate from the credit limit of the respective postal carrier thus can be predetermined in a simple manner.

The first item of transaction control information and the second item of transaction control information preferably relate to the same transaction feature. The transaction feature can be an arbitrary feature of the transaction. For example, in the case of the franking machine it can be the postage amount that is loaded with the transaction.

In addition, the second transaction control information can be associated with a number of data processing units, such that the transactions of a number of data processing units can be influenced or monitored via a single central specification. In the case of a franking machine, for example, internal limits for the downloading of postage that deviate from the credit limit of the respective postal carrier can be predetermined in a simple manner.

Furthermore, variable items of transaction control information that depend on preceding transactions of the data processing units of the group or on arbitrary other parameters also can be predetermined for a group composed of a number of data processing units via the second item of transaction control information. Arbitrarily complex rules thus can be predetermined by the second item of transaction control information, according to which rules the transactions of the data processing units of the group are influenced or monitored. Thus an internal total limit for downloading postage can be simply predetermined for a group of franking machines, for example for a specific time span. In the simplest case, as the predetermined rule, only the consumption of the internal total limit for the group is to be checked. If this is consumed, further downloading of postage into franking machines of the group is prevented, independently of which franking machines have consumed the total limit.

If not only the first data center but also a further data center is involved in the first transaction, in the first specification step the first item of transaction control information can thus be provided, both, to the first data center and/or to the further data center in order to be able to be observed in the framework of the first transaction. In the first specification step, the first item of transaction control information is preferably provided to the first data center in order to enable a fast execution of the transaction. The same is true for the second item of transaction control information. In the second specification step, this can also be provided, both, to the first data center and/or to the further data center. It is also preferably provided to the first data center in the second specification step. Apart from that, in this context the first data center can be the first source itself.

The transfer of the respective transaction control information to the first data center can ensue in an arbitrary manner. Thus an offline transmission can be selected, for example via post, telephone, telefax, e-mails or other electronic document or file transfer (for example via EDI, FTP etc.). An online transmission with a direct communication with the first data center is preferably selected. Preferably the first item of transaction control information is provided in the first specification step to the first data center via a communication connection between the first source and the first data center. Additionally or alternatively, in the second specification step the second item of transaction control information is provided to the first data center via a communication connection between the second source and the first data center.

The source of the respective transaction control information can be of any type. In particular the source can also be a person, but preferably is a remote data center.

The first transaction can be initiated in any manner and from any side. It is frequently initiated by the first data processing unit. An item of request information, different from the first and second items of transaction control information and associated with the first transactions, is preferably predetermined by the first data processing unit and provided to the first data center in a request step preceding the implementation step. The first transaction is then implemented in the implementation step dependent on the request information.

If this request information different from the first and second transaction control information is not consistent with the first item of transaction control information or the second item of transaction control information, the transaction can be completely refused. A corresponding notice is then preferably transferred to the first data processing unit.

Preferably, however, the transaction is not refused, but instead ensues in the implementation step dependent on the request information in the framework of the limits predetermined by the first or second item of transaction control information. In other words, the implementation of the first transaction then ensues in the implementation step dependent on the request information insofar as the request information is compatible with the first item of transaction control information and/or the second item of transaction control information. If, for example, a postage amount that exceeds an internal limit predetermined by the second item of transaction control information is requested at a franking machine, a rule can be provided that causes loading of a reduced postage amount with which the internal limit is exactly consumed, in the course of the first transaction.

Preferably, in a first testing step of the implementation step the compatibility of the request information with the first item of transaction control information is checked. In a first modification step, the request information is then modified (dependent on the result of the testing in the first testing step and a predeterminable first modification criterion) such that the request information is compatible with the first transaction control information. Additionally or alternatively, the compatibility of the request information with the second transaction control information is checked in a second testing step of the implementation step. In a second modification step, the request information is then modified (dependent on the result of the testing in the second testing step and a predeterminable second modification criterion) such that the request information is compatible with the second transaction control information. The respective modification criterion can be predetermined in the form of an arbitrarily complex rule.

A precedence rule between the first and the second items of transaction control information preferably is predetermined. For example, precedence for the first item of transaction control information over the second item of transaction control information can be predetermined. Thus the implementation of the first transaction in the implementation step can ensue dependent on the second item of transaction control information, insofar as the second item of transaction control information is compatible with the first item of transaction control information.

The compatibility of the second item of transaction control information with the first item of transaction control information preferably is checked in a third testing step. The second item of transaction control information then is modified in a third modification step, dependent on the result of the testing in the third testing step and a predeterminable third modification criterion, such that the second transaction control information is compatible with the first transaction control information. Here as well the modification criterion can be predetermined in the form of an arbitrarily complex rule.

In variants of the inventive method, a protocolling of at least one part of the information exchanged between the first data processing unit and the first data center ensues in the framework of the first transaction in a protocolling step. A first item of protocol information is thereby generated. At least one part of the first protocol information then preferably is transmitted to the second source in a report step following the protocolling step. It is thereby possible in a simple manner to give an owner of a number of first data processing units an arbitrarily detailed report about the transaction activity of his data processing units. In other words, the owner can promptly monitor his data processing units centrally and without having to directly access them.

Depending on the security level of the respective transaction, at least the information exchanged between the first data processing unit and the first data center can be secured by cryptographic means. The transaction can be varied depending on the type and content. If the exchanged data should not be visible for unauthorized third parties, for example, the data are normally encoded by suitable means, for example encrypted. If an emphasis is on the absence of corruption of the exchanged data, the data are authenticated by suitable means. A series of known authentication methods are available that need not be described in detail herein. Message Authentication Codes (MAC) or digital signatures are examples. It is understood that the specified protection can be applied to all remaining aforementioned communications between other communication partners.

As mentioned above, a number of data processing units can be combined into groups for which the second item of transaction control information can then be predetermined in a single specification. Different second items of transaction control information for different data processing units can be combined into an item of group transaction control information. However, it is likewise possible to provide a second item of transaction control information common to a number of data processing units by association of the second item of transaction control information with these data processing units. The association with these data processing units ensues by means of a part of the group transaction control information.

In variants of the inventive method, a number of data processing units are provided that are associated with a first group of data processing units. A first transaction between a data processing unit of the first group and the first data center is implemented in the implementation step. An item of group transaction control information associated with the first group that includes the second item of transaction control information is provided by the second source in the second specification step.

It is understood that an arbitrarily fine partitioning into groups and sub-groups etc. can be provided for the existing data processing units. In other words, an arbitrarily significantly partitioned hierarchy of the data processing units can be provided via which an exact, prompt monitoring or influencing of the transactions of the existing data processing units is possible in a simple manner.

The present invention furthermore concerns an arrangement to implement at least a first transaction between a first data processing unit (in particular a franking machine) and a remote first data center that can be connected with the first data processing unit via a communication connection to implement the first transaction. The first data center has a first memory in which a first item of transaction control information provided by a first source is stored and associated with the first data processing unit. The first data center is furthermore fashioned to implement the first transaction dependent on the first item of transaction control information. In accordance with the invention the first data center has a second memory in which a second item of transaction control information provided by a second source is stored and associated with the first data processing unit. Furthermore, the first data center is fashioned to implement the first transaction dependent on the second item of transaction control information.

This arrangement is suitable for implementation of the inventive method. The variants and advantages specified above in connection with the inventive method can be realized to the same degree with said arrangement.

The present invention furthermore concerns a data center for an inventive arrangement that is fashioned to function as the first data center. In other words, this data center has at least one part of the features of the first data center described above or in the following.

### DESCRIPTION OF THE DRAWINGS

FIG. 1 is a block diagram of a preferred embodiment of the inventive arrangement to implement the inventive method.

FIG. 2 is a flowchart of a preferred embodiment of the inventive method that can be executed with the arrangement from FIG. 1.

FIG. 3 is a flowchart of a further preferred embodiment of the inventive method that can be executed with the arrangement from FIG. 1;

FIG. 4 is a part of a flowchart of a further preferred embodiment of the inventive method that can be executed with the arrangement from FIG. 1.

### DESCRIPTION OF THE PREFERRED EMBODIMENTS

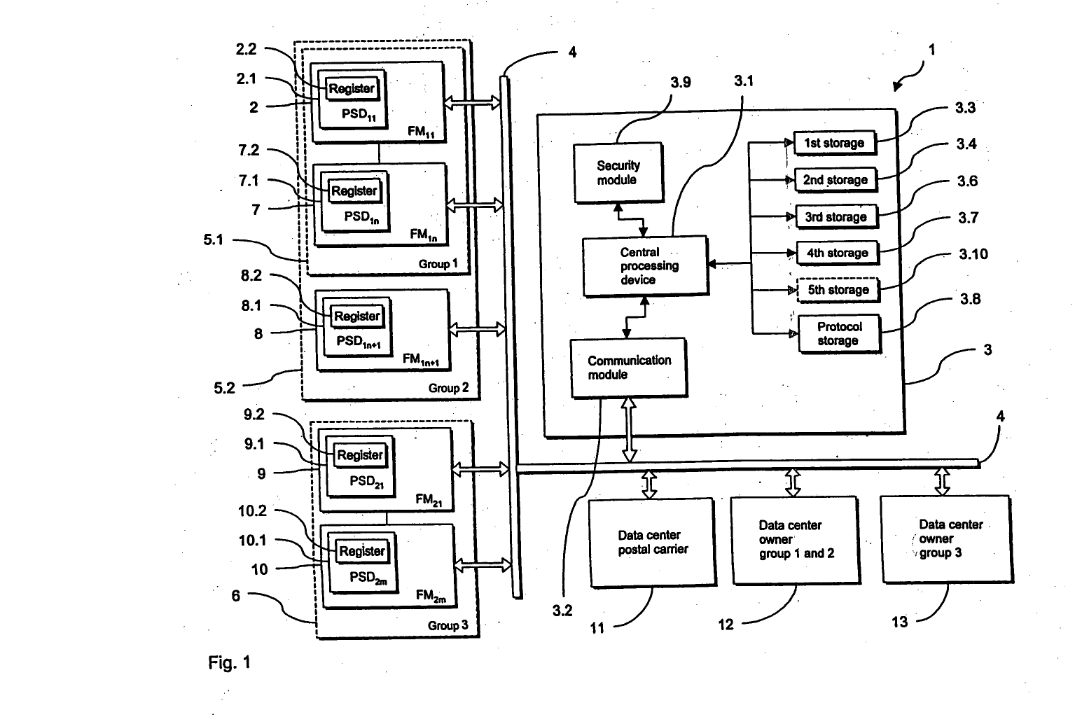

FIG. 1 shows a block diagram of a preferred embodiment of the inventive arrangement 1 for implementation of the inventive method. The arrangement includes a first data processing unit 2 in the form of a first franking machine (FM₁₁) that can communicate with a first data center 3 of a service provider via a communication connection.

The first franking machine 2 includes a postal security module (PSD₁₁) 2.1 with a credit (balance) memory 2.2 in the form of a postal register. Among other things, a descending register, the value of which is reduced by the printed postage value with each franking imprint executed by the first franking machine 2, is located in this credit memory 2.2.

The service provider in the present example is the manufacturer of the franking machine 2. As a service for the first franking machine 2, the service provider provides the loading of postage into the credit memory 2.2 of the security module 2.1. If this service is executed in the course of a first transaction between the first franking machine 2 and the first data center, among other things the value of the descending register is increased by the downloaded value. The first transaction is thereby conducted via a communication connection between the first franking machine 2 and the first data center 3.

The first data center 3 has a central processing device 3.1 that is connected with a communication module 3.2, for example a modem bank or the like. The communication connection with the first franking machine 2 (which likewise has a corresponding (not shown) communication module for this purpose) can be established with this communication module 3.2 via a communication network 4.

In addition to the first franking machine 2, the arrangement 1 includes further franking machines. These are associated with three groups, a first group 5.1, a second group 5.2 and a third group 6. n franking machines are associated with the first group 5.1, of which only the first franking machine 2 and the n^{th} franking machine 7 (FM₁ₙ) are shown in FIG. 1. The franking machines of the first group 5.1 and the franking machine 8 (FM₁ₙ₊₁) are associated with the second group 5.2.

m franking machines, of which only the franking machine 9 (FM₂₁) and the m^{th}-franking machine 10 (FM₂ₘ) are shown in FIG. 1, are associated with the third group 6. The franking machines 7, 8, 9 and 10 are designed like the first franking machine 2. They respectively comprise a postal security module 7.1, 8.1, 9.1, 10.1 (PSD₁ₙ. PSD₁ₙ₊₁. PSD₂₁. PSD₂ₘ) with a credit memory 7.2, 8.2, 9.2, 10.2 in the form of a postal register.

The franking machines of the first group 5.1 and the second group 5.2 are located at sites, spatially separate from one another, of a first organization that owns these franking machines. The franking machines of the second group 6 are likewise located at sites, spatially separate from one another, of a second organization that owns these franking machines.

The first data center 3 furthermore can be connected with a remote data center 11 of a postal carrier via the communication network 4. This postal carrier conveys the mail pieces franked with the franking machine 2, whereby it accepts a valid franking imprint as an evidence of payment for the carrier fee.

In a payment system known as a post-payment system implemented in the present case, the loading event implemented in the framework of the first transaction is initially protocolled in the first data center 3 of the service provider and is transmitted to the second data center 11 of the postal carrier at a later point in time. The postal carrier then directly deducts the loaded amount with regard to the owner of the franking machine.

For security, a separate contract between the postal carrier and the owner of the respective franking machines 2, 7, 8, 9, 10 exists for each franking machine 2, 7, 8, 9, 10. For this reason, a separate master data set is held and maintained for the respective franking machines 2, 7, 8, 9, 10 in the respective data centers 3 and 11. In the first data center 3, this master data set is respectively stored in a first memory 3.3 connected with the central processing device 2.1. This master data set, which is synchronized at regular intervals, normally contains a credit limit. This credit limit, which represents a first item of transaction control information TSI₁ in the sense of the present invention, is provided on the part of the postal carrier using specific criteria. For the respective franking machines 2, 7, 8, 9 and 10, it establishes a maximum postage amount that can be loaded into the respective franking machines 2, 7, 8, 9 and 10 within a specific time span. The credit limit applies to a first transaction feature of specific transactions, namely the postage amount that is loaded into the franking machine 2, 7, 8, 9 or, 10 with such a transaction.

The first data center 3 can be connected via the communication network 4 with a remote third data center 12 of the owner of the franking machines of the first and second groups 5.1 and 5.2. As explained in further detail below, the owner of the first and second groups 5.1 and 5.2 can influence the transactions between the first data center 3 and the franking machines of the first and second group 5.1 and 5.2 via the connection of the third data center 12 with the first data center 3. Additionally, the owner can monitor transactions between the first data center 3 and the franking machines of the first and second groups 5.1 and 5.2 centrally and promptly. Both can ensue in an advantageous manner without direct access of the third data center 12 to the franking machines of the first and second group 5.1 and 5.2.

The first data center 3 can be connected via the communication network 4 with a remote fourth data center 13 of the owner of the franking machines of the third group 6. Here as well the owner of the third group 6 can influence the transactions between the first data center 3 and the franking machines of the third group 6 via the connection of the fourth data center 13 with the first data center 3. Additionally, the owner can monitor the transactions between the first data center 3 and the franking machines of the third group 6 centrally and promptly. Both can likewise ensue in an advantageous manner without direct access of the third data center 12 to the franking machines of the third group 6.

The first data center 3 has a first memory 3.3 in which specifications of the third data center 11 are stored. These specifications include, among other things, first items of transaction control information TSI₁ that are associated with the respective franking machine and whose function is explained in further detail in the following.

The first data center 3 furthermore has a second memory 3.4 in which specifications of the third data center 12 and the fourth data center 13 are stored. These specifications include, among other things, second items of transaction control information TSI₂ that are associated with franking machines and the function of which is likewise explained in further detail below.

The first data center 3 furthermore has a third memory 3.5 in which, among other things, first modification criteria MK₁ are stored that are associated with franking machines. Among other things, second modification criteria MK₂ that are likewise associated with franking machines are stored in a fourth memory 3.6 of the first data center 3. The function of these modification criteria is explained in further detail below.

The first data center 3 furthermore has a protocol memory 3.7 in which, among other things, protocol information Pi regarding implemented transactions is stored. Finally, the first data center has another security module 3.8 connected with the processing device 3.1. The security module 3.8 provides, among other things, cryptographic means for securing data transfers.

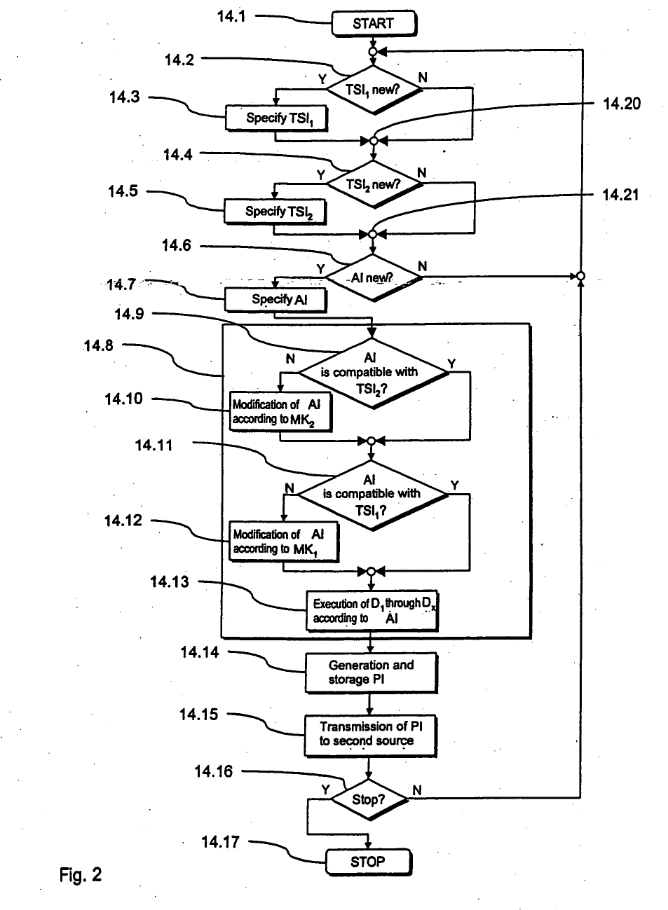

The workflow of the inventive method for implementation of transactions between the first data center 3 and the first franking machine 2 is described in detail in the following with reference to FIGS. 1 and 2.

After the method workflow has been started in step 14.1, in step 14.2 it is initially checked whether a new specification of a first item of transaction control information TSI₁ should ensue. If this is the case, in a first specification step 14.3 a first item of transaction control information TSI₁ is provided for the first franking machine 2 in the form of a credit limit. This first item of transaction control information TSI₁ is provided by the second data center 11 as a first source. It is transferred by the second data center 11 to the first data center 3 via the communication network 4 as a first specification data set for the first franking machine 2. There it is stored in the first memory 3.3 for updating of the master data set of the first franking machine 2. The specification and transmission of the first item of transaction control information TSI₁ can ensue at regular intervals or as needed.

In step 14.4, it is then checked whether a new specification of a second item of transaction control information TSI₂ should ensue. If this is the case, in a second specification step 14.5 a second item of transaction control information TSI₂ is provided that comprises an organization-internal credit limit for the first franking machine 2. This organization-internal credit limit specifies an organization-internal, predetermined upper limit for the postage to be loaded into the first franking machine 2 over a specific predetermined span of time. The organization-internal credit limit, and therewith also the second item of transaction control information TSI₂, thus likewise refer to the same transaction feature as the first item of transaction control information TSI₁, namely to the first transaction feature cited above, thus the postage amount that is loaded into the franking machine 2 with such a transaction.

The second item of transaction control information TSI₂ is provided by the third data center 12 as a second source. It is transferred by the third data center 12 to the first data center 3 via the communication network 4 in a second specification data set associated with the first franking machine 2. There (in the first data center 3) the second specification data set is stored with the second item of transaction control information TSI₂ in the second memory 3.4.

The organization-internal credit limit in the second specification data set, thus the second item of transaction control information TSI₂, is associated not only with the first franking machine 2 but also—by references in the second specification data set—with all other franking machines of the first group 5.1. In other words, the second specification data set thus includes an item of group transaction control information for all franking machines of the first group 5.1. A second item of transaction control information TSI₂ can be provided for all franking machines of the first group 5.1 with a single transmission of the second specification data set.

A credit limit deviating from the credit limit for the franking machines of the first group 5.1 is predetermined for the franking machine 8 by the third data center 12 in a separate third specification data set. In other words, with the present invention it is thus possible to effect arbitrary divisions of the franking machines into groups and sub-groups etc. and to achieve an influencing of the transactions adapted to the respective requirements by this division.

Furthermore, a group item of transaction control information for all franking machines of the second group 5.2 is provided by the third data center 12 with a fourth specification data set. This specifies a time interval after which each franking machine of the second group 5.2 is prompted to make a detailed status report to the first data center 3 in the course of a transaction with the first data center 3.

The group transaction control information thus refers to a second transaction feature, namely the report data transmitted in the course of the respective transaction. The point in time and/or the scope of the report data transmitted according to the group transaction control information can differ from the point in time and/or scope of the transmitted report data that are provided according to a further item of transaction control information. This further item of transaction control information thus likewise refers to the same transaction feature, namely the second transaction feature. This further item of transaction control information can be provided, for example, by the postal carrier as a first source.

Finally, the item of group transaction control information of the first specification data set provides a credit limit rule for all franking machines of the second group 5.2. This states that the sum of the credit amounts loaded into all franking machines of the second group 5.2 within a specific time span may not exceed a specific amount. In other words, a group credit limit is provided for all franking machines of the second group 5.2.

It is understood that the transmission of the specification data set and the transaction control information contained therein to the first data center in the first or second specification step can also ensue in other ways in other variants of the invention. The transmission can ensue, for example, via mail, telephone, telefax, e-mail or other electronic document or file transfer (for example via EDI, FTP etc.). Furthermore, the specification and transmission of the specification data set can ensue at regular intervals, or as needed.

Furthermore, it is understood that, in other variants of the invention, the respective sets of transaction control information can include one or more arbitrary other specifications for a service to be implemented for the franking machine in the framework of the transaction in addition to or instead of the credit limit or the report interval. In other words, the respective sets of transaction control information can refer to any other common transaction feature.

In step 14.6, it is then checked whether a new service request by the franking machine should ensue with the specification of a request information AI. If this is not the case, the method returns back to step 14.2. Otherwise, in request step 14.7 the franking machine 2 initiates a transaction with the first data center 3 in which the franking machine 2 contacts the first data center 3 via the communication network 4 and thereby transmits a request data set. This request data set includes an item of request information AI with which the implementation of a plurality of services D₁ through Dₓ is requested. The service D₁, may be the loading of a specific credit into the franking machine 2.

This first transaction is henceforth implemented in a series of sub-steps in implementation step 14.8. In testing step 14.9, the processing device 3.1 initially checks whether the request information AI is compatible with the second item of transaction control information TSI₂ stored in the second memory 3.4 and associated with the franking machine 2. Thus it is initially checked whether the organization-internal credit limit predetermined for the franking machine 2 is exceeded with the requested amount. Furthermore, it is checked whether the group credit limit predetermined by the credit limit rule for all franking machines of the second group 5.2 is exceeded.

Upon detection of a discrepancy between the request information AI and the transaction control information TSI₂, in both cases the processing device 3.1 changes the request information AI in a modification step 14.10. For this purpose, it accesses the second modification criterion MK₂ stored in the fourth memory 3.5 and associated with the franking machine 2. This second modification criterion MK₂ provides in which manner the request information AI is changed in the case of such a discrepancy.

In the present case, the second modification criterion MK₂ states that the request information AI is modified such that it contains the maximum credit amount still allowable with which the organization-internal credit limit and the group credit limit are adhered to.

The organization-internal credit limit of the franking machine 2 predetermined by the transaction control information TSI₂ is at Lₘₐₓ=1000 Euros (or whatever is the applicable currency). For example, if the franking machine 2 has already loaded Lₛᵤₘ=700 Euros in the predetermined time span T and it now requests an amount L_{AI}=400 Euros with the request information AI, in the modification step 14.10 the request information AI modifies the request information AI such that the requested amount only amounts to the maximum L_{AI}′=300 Euros allowable according to the organization-internal credit limit.

Additionally, if the group credit limit of the first group 5.1 is L_{Gmax}=3000 Euros in the predetermined time span T and L_{Gsum}=2800 Euros have already been loaded by the franking machines of the first group 5.1 in the predetermined time span T, the request information AI is modified in the modification step 14.10 such that the requested amount only amounts to the maximum L_{AI}′=200 Euros allowable according to the group credit limit.

It is understood that, for the case that this amount is then loaded into the franking machine 2, none of the franking machines of the first group 5.1 can load further postage in the predetermined time span T since the group credit limit of the first group 5.1 is then consumed.

In other variants of the invention, the request information is not modified given an established incompatibility; but instead the entire transaction or at least the requested service to which the incompatibility is related is interrupted, or not executed. Thus, for example, a loading event can be interrupted when the predetermined credit limit is exceeded, while further requested or, respectively, upcoming services (for example the loading of a new rate table into the franking machine) can be executed.

In testing step 14.11, the processing device 3.1 checks whether the request information AI is compatible with the first item of transaction control information TSI₁ stored in the second memory 3.4 and associated with the franking machine 2. It is thus checked whether the credit limit predetermined for the franking machine 2 by the postal carrier is exceeded with the requested amount.

Here as well, upon detection of a discrepancy between the modified request information AI and the transaction control information TSI₁, the processing device 3.1 changes the modified request information AI in a further modification step 14.12. For this, it accesses the first modification criterion MK₁ stored in the third memory 3.5 and associated with the franking machine 2. This first modification criterion MK₁ provides in which manner the request information AI is modified in the case of such a discrepancy.

In the present case, the first modification criterion MK₁ states (analogous to the second modification criterion MK₂) that the request information AI is modified such that the franking machine 2 obtains the maximum still-allowable credit amount with which the credit limit predetermined by the postal carrier is adhered to.

The credit limit of the franking machine 2 predetermined by the postal carrier via the transaction control information TSI₁ is L_{Pmax}=800 Euros in the predetermined time span T. For the above example, the request information AI is modified in the modification step 14.12 such that the requested amount only amounts to the maximum L_{AI}′=100 Euros allowable according to the credit limit predetermined by the postal carrier.

The respective modification criterion is predetermined by the data center 11, 12 or 13. In other words, it represents a conflict solution strategy according to which conflicts between the requests and specifications are solved in the framework of the transactions.

The services D₁ through Dₓ are then sequentially executed in the execution step 14.13 according to the modified request information AI. The request information AI may have been modified corresponding to the first and second items of transaction control information, such that not only the service D₁ but also further services according to the first and second items of transaction control information are executed. Thus, for example, via the second item of transaction control information TSI₂ it can be provided that a detailed status report is requested from the franking machine 2 at predeterminable points in time as service Dₓ.

The selected series of the testing and modification steps 14.9 through 14.12, ensures that the credit limit predetermined by the postal carrier has precedence over the organization-internal credit limit. The credit limit predetermined by the postal carrier is thus adhered to in every case. In other words, the implementation of the transaction ensues dependent on the request information and the second item of transaction control information only insofar as these are compatible with the credit limit predetermined by the postal carrier.

In protocolling step 14.14, the processing device 3.1 then generates an item of protocol information PI in a predetermined format and scope for the first transaction and stores this in the protocol memory 3.8. The protocol memory 3.8 thus contains, among other things, a protocol for each franking machine about the activities (visible for the data center) of the franking machine since its initialization.

In report step 14.15, at least one part of the protocol information PI is transmitted in a report data set to the second source, thus the third data center 12. If applicable, this report step is only implemented at specific points in time predeterminable by the second source. This can be predetermined, for example, by the third data center 12 with the transmission of the second item of transaction control information to the first data center 3.

Arbitrary monitoring scenarios with which the owner can variably monitor the owner's franking machine according to his need can be realized with this. Thus, for example, with the transmission of the second transaction control information, the second source can provide that the credit loading activities of the franking machines of the first group 5.1 should be monitored for a specific time span. The report data set generated in the first data center then contains the current total sum of the load amounts that have been loaded by the franking machines of the first group 5.1 since the beginning of this time span. The predeterminable time span can be a time interval of specific length (for example 20 days) whose beginning is marked by the arrival of the associated transaction control information in the first data center. It can likewise be a calendar-established time span (for example from the first day to the last day of a respective calendar month).

This enables the owner of the franking machines to obtain a detailed, prompt overview formatted corresponding to his requirements, not only about the activities of individual franking machines but also about the overall activities of any defined groups of franking machines. It is in particular possible to provide an alarm function for the respective owner: according to this, the owner or the data center associated with this is immediately informed in arbitrary detail when a monitoring criterion predetermined by him is fulfilled. This monitoring criterion can be, for example, the exceeding or the reaching of a credit limit.

In step 14.16, finally it is checked whether the method workflow should be ended. If this is the case, the execution ends in step 14.17. Otherwise the method returns back to the step 14.2.

All transfers of security-relevant data (in particular billing-relevant data) between the franking machines 2, 7, 8, 9, 10 or the data centers 1 1, 12, 13 and the data center 2 are secured in an adequate known manner by cryptographic means. It can be varied depending on the type and content of the transaction. If the exchanged data, for example, should not be visible for unauthorized third parties, they are normally correspondingly encoded by suitable means, for example encrypted. If a focus is placed on the traceable lack of adulteration of the exchanged data, they are authenticated by suitable means, for example by Message Authentication Codes (MAC) or digital signatures.

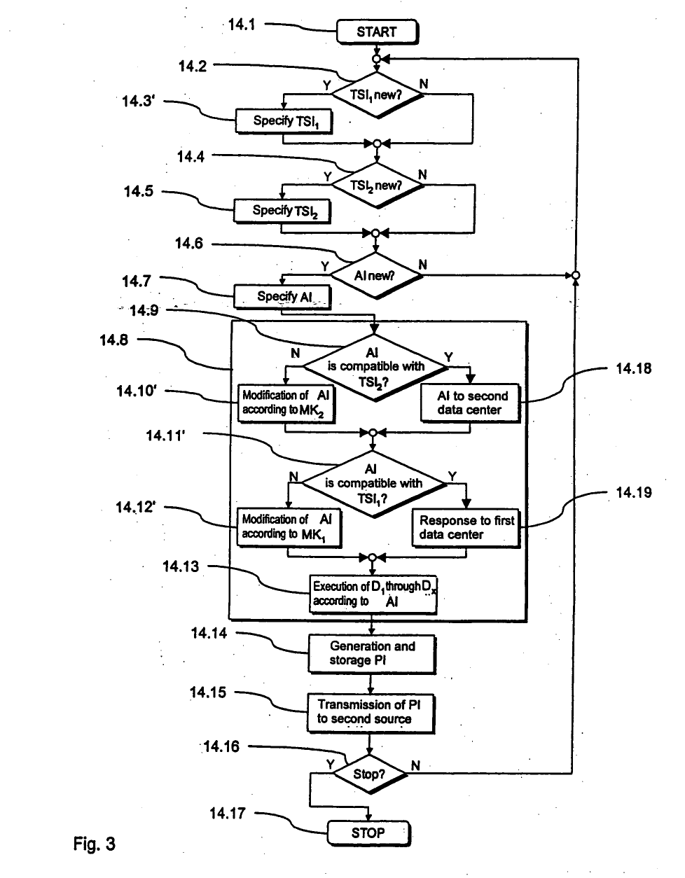

FIG. 3 shows a flowchart of a further preferred embodiment of the inventive method that can be executed with the arrangement of FIG. 1. This embodiment differs in only a few steps from the embodiment of FIG. 2, such that here only the differences shall be discussed. In particular identical steps in FIGS. 2 and 3 are provided with the same reference numerals.

The significant difference regarding the embodiment from FIG. 2 is that the second data center 11 of the postal carrier is a participant in the transaction. As a consequence, in this variant the first item of transaction control information TSI₁ does not necessarily have to be communicated to the first data center 3 in the first specification step 14.3′ after its specification by the second data center 11. Rather, it is sufficient that the first item of transaction control information TSI₁ is present in the second data center 11. The first memory 3.3 of the first data center 3, if necessary, can remain empty or be absent.

If the testing in the testing step 14.9 results in the request information AI not being compatible with the second item of transaction control information TSI₂ stored in the second memory 3.4 and associated with the franking machine 2, in the modification step 14.10′ the request information AI is modified according to the second modification criterion MK₂. The modified request information AI is subsequently transferred to the second data center 11 of the postal carrier in this step. The modified request information AI is thereby provided with a digital signature or another authentication means of the first data center 3 in order to make the authenticity of the modification traceable.

If the testing in the testing step 14.9 results in a determination that the request information AI is compatible with the second item of transaction control information TSI₂, the request information AI is directly transmitted to the second data center 11 of the postal carrier in the step 14.18.

The testing step 14.11′ then ensues in the second data center 11 of the postal carrier. The first modification criterion MK₁ is then present at least in the second data center 11. The third memory 3.5 of the first data center 3 can, if necessary, remain empty or, respectively, be absent.

If the testing in the testing step 14.11′ results in a determination that the request information AI is not compatible with the first item of transaction control information TSI₁ present in the second data center 11 and associated with the franking machine 2, in the modification step 14.12′ the request information AI is modified by the second data center 11 according to the first modification criterion MK₁. The modified request information AI is subsequently transferred to the first data center 3 in this step, together with corresponding authorization information. Among other things, the modified request information AI is provided with a digital signature or another authentication means of the second data center 11 in order to make the authenticity of the modification traceable.

If the testing in the testing step 14.11′ results in a determination that the request information AI is compatible with the first item of transaction control information TSI₁, the request information AI is directly transmitted to the first data center 3 of the postal carrier in the step 14.19, together with corresponding authorization information.

All remaining steps of this variant of the inventive method proceed as specified in connection with FIG. 2.

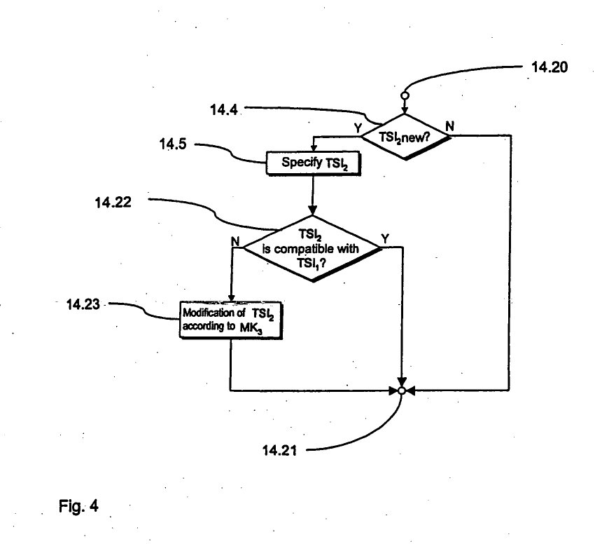

FIG. 4 shows a part of a flowchart of a further preferred embodiment of the inventive method that can be executed with the arrangement from FIG. 1. This embodiment differs in only a few steps from the embodiment from FIG. 2, such that here only the differences shall be discussed. Identical steps in FIGS. 2 and 3 are provided with the same reference numerals. FIG. 4 shows the modified section of the method flow between the points 14.20 and 14.21 from FIG. 2.

The significant difference regarding the embodiment of FIG. 2 is that it is not the request information AI but rather the second item of transaction control information TSI₂ that is tested for compatibility with the first item of transaction control information TSI₁ and is modified if applicable.

In this variant, after the second specification step 14.5 it is checked in testing step 14.22 whether the second item of transaction control information TSI₂ is compatible with the first item of transaction control information TSI₁. If this is not the case, the processing device 3.1 modifies the second item of transaction control information TSI₂ in a modification step according to a third modification criterion MK₃ such that it is compatible with the first item of transaction control information TSI₁. This third modification criterion MK₃ can have been provided by the second data center 11 and stored in a fifth memory 3.10 of the first data center 3.

In this variant the steps 14.11 and 14.12 from FIG. 2 are omitted, while the remaining proceed as specified in connection with FIG. 2.

The individual steps of the variants of the inventive method specified in the preceding preferably are executed sequentially, immediately after one another, but it is understood that longer time intervals can be present between individual steps.

Furthermore, it is understood that the separate memories specified herein do not necessarily have to be formed by separate memory modules. Alternatively, they can be fashioned at least in part as separate memory regions of a single memory module.

The present invention is described above using examples from the field of franking machines, but it is understood that it can also be used for other application fields in which data processing units that implement transactions with a remote data center should be centrally influenced or monitored by specifications to the remote data center.

Although modifications and changes may be suggested by those skilled in the art, it is the intention of the inventor to embody within the patent warranted hereon all changes and modifications as reasonably and properly come within the scope of his contribution to the art.

1. A method for implementing a transaction between a data processing unit and a data center remote from said data processing unit, comprising the steps of:
in a first specification step, providing a first item of transaction control information, associated with said data processing unit, from a first source and in a second specification step, providing a second item of transaction control information, associated with said data processing unit, from a second source; and
in an implementation step following said first and second specification step, implementing said first transaction, via a communication link between said data processing unit and said data center, dependent on said first and second items of transaction control information.

2. A method as claimed in claim 1 comprising providing both of said first item of transaction control information and said second item of transaction control information with reference to the same transaction feature of said transaction.

3. A method as claimed in claim 1 comprising providing said first item of transaction control information to said data center in said first specification step.

4. A method as claimed in claim 3 comprising providing said first item of transaction control information to said data center in said first specification step via a communication link between said first source and said data center.

5. A method as claimed in claim 1 comprising providing said second item of transaction control information to said data center in said second specification step.

6. A method as claimed in claim 5 comprising providing said second item of transaction control information to said data center in said second specification step via a communication link between said second source and said data center.

7. A method as claimed in claim 1 wherein said data center is a first data center, and comprising providing said first item of transaction control information from a second data center, remote from said data processing unit, as said first source.

8. A method as claimed in claim 1 wherein said data center is a first data center, and comprising providing said second item of transaction control information from a second data center, remote from said data processing unit, as said second source.

9. A method as claimed in claim 1 wherein said data center is a first data center, and comprising providing said first item of transaction control information from a second data center, remote from said data processing unit, as said first source, and providing said second item of transaction control information from a third data center, remote from said data processing unit, as said second source.

10. A method as claimed in claim 1 comprising:
in a request step, generating an item of request information, associated with said transaction and being different from said first and second items of transaction control information, at said data processing unit;
making said item of request information available to said data center; and
in said implementation step, implementing said transaction dependent on said item of request information and said first and second items of transaction control information.

11. A method as claimed in claim 10 comprising implementing said transaction in said implementation step only insofar as said item of request information is compatible with at least one of the first item of transaction control information and the second item of transaction control information.

12. A method as claimed in claim 11 comprising:
in said implementation step, checking compatibility of said item of request information with said first item of transaction control information and, if said item of request information is not compatible with said first item of transaction control information, modifying said item of request information according to a predetermined first modification criterion to make said item of request information compatible with said first item of transaction control information; and/or
in said implementation step, checking compatibility of said item of request information with said second item of transaction control information and, if said item of request information is not compatible with said second item of transaction control information, modifying said item of request information according to a predetermined second modification criterion to make said item of request information compatible with said second item of transaction control information.

13. A method as claimed in claim 1 comprising implementing said transaction in said implementation step dependent on said second item of transaction control information together with said first item of transaction control information, only insofar as said second item of transaction control information is compatible with said first item of transaction control information.

14. A method as claimed in claim 13 comprising:
in a deducing step, checking compatibility of said second item of transaction control information with said first item of transaction control information; and
if said second item of transaction control information is not compatible with said first item of transaction control information, modifying said second item of transaction control information according to a modification criterion to make said second item of transaction control information compatible with said first item of transaction control information.

15. A method as claimed in claim 1 comprising executing a service for said data processing unit in said transaction.

16. A method as claimed in claim 15 wherein executing said service for said data processing unit comprises modifying a state of said data processing unit.

17. A method as claimed in claim 1 wherein said data processing unit is a franking machine, and comprising, in said transaction, loading new credit into said franking machine.

18. A method as claimed in claim 1 comprising exchanging information between said data processing unit and said data center in said transaction and, in said implementation step, protocoling at least a portion of said information and from said protocoling generating an item of protocol information.

19. A method as claimed in claim 18 comprising transmitting at least a portion of said item of protocol information to said second source as a report.

20. A method as claimed in claim 1 comprising, in said implementation step, exchanging information between said data processing unit and said data center and securing said information using at least one procedure selected from the group consisting of encrypting said information and authenticating said information.

21. A method as claimed in claim 1 comprising:
providing a number of data processing units, forming a group of data processing units including said data processing unit;
implementing said transaction between any of said data processing units in said group and said data center; and
providing an item of group transaction control information associated with said group, and including said second item of transaction control information, from said second source.

22. An arrangement for implementing a transaction comprising:
a data processing unit;
a data center remote from said data processing unit able to communicate with said data processing unit via a communication link;
a first source that provides a first item of transaction control information, associated with said data processing unit, for a transaction to be implemented between said data processing unit and said data center;
a second source that provides a second item of transaction control information, associated with said data processing unit, for said transaction;
a first memory at said data center in which first item of transaction control information is stored;
a second memory at said data center at which said second item of transaction control information is stored; and
said data center implementing said transaction dependent on said first and second items of transaction control information.

23. An arrangement as claimed in claim 22 wherein said first source and said second source respectively provide said first item of transaction control information and said second item of transaction control information with reference to the same transaction feature of said transaction.

24. An arrangement as claimed in claim 22 wherein said first source provides said first item of transaction control information to said data center in a specification step.

25. An arrangement as claimed in claim 24 wherein said first source provides said first item of transaction control information to said data center in said specification step via a communication link between said first source and said data center.

26. An arrangement as claimed in claim 22 wherein said second source provides said second item of transaction control information to said data center in a specification step.

27. An arrangement as claimed in claim 26 wherein said second source provides said second item of transaction control information to said data center in said specification step via a communication link between said second source and said data center.

28. An arrangement as claimed in claim 22 wherein said data center is a first data center, and wherein said first source is a second data center, remote from said data processing unit.

29. An arrangement as claimed in claim 22 wherein said data center is a first data center, and wherein said second source is a second data center, remote from said data processing unit.

30. An arrangement as claimed in claim 22 wherein said data center is a first data center, and wherein said first source is a second data center, remote from said data processing unit, and wherein said second source is a third data center, remote from said data processing unit.

31. An arrangement as claimed in claim 22 wherein said data processing unit, in a request step, generates an item of request information, associated with said transaction and being different from said first and second items of transaction control information, and makes said item of request information available to said data center, wherein said data center, in said implementation step, implements said transaction dependent on said item of request information and said first and second items of transaction control information.

32. An arrangement as claimed in claim 31 wherein said data center implements said transaction in said implementation step only insofar as said item of request information is compatible with at least one of the first item of transaction control information and the second item of transaction control information.

33. An arrangement as claimed in claim 32 comprising:
said data center, in said implementation step, checking compatibility of said item of request information with said first item of transaction control information and, if said item of request information is not compatible with said first item of transaction control information, modifying said item of request information according to a predetermined first modification criterion to make said item of request information compatible with said first item of transaction control information; and/or
said data center, in said implementation step, checking compatibility of said item of request information with said second item of transaction control information and, if said item of request information is not compatible with said second item of transaction control information, modifying said item of request information according to a predetermined second modification criterion to make said item of request information compatible with said second item of transaction control information.

34. An arrangement as claimed in claim 22 wherein said data center implements said transaction in said implementation step dependent on said second item of transaction control information together with said first item of transaction control information, only insofar as said second item of transaction control information is compatible with said first item of transaction control information.

35. An arrangement as claimed in claim 34 comprising:
said data center, in a checking step, checking compatibility of said second item of transaction control information with said first item of transaction control information; and
said data center, if said second item of transaction control information is not compatible with said first item of transaction control information, modifying said second item of transaction control information according to a modification criterion to make second item of transaction control information compatible with said first item of transaction control information.

36. An arrangement as claimed in claim 22 wherein said data center executes a service for said data processing unit in said transaction.

37. An arrangement as claimed in claim 36 wherein said data center executes said service for said data processing unit by modifying a state of said data processing unit.

38. An arrangement as claimed in claim 22 wherein said data processing unit is a franking machine, and wherein said data center, in said transaction, loads new credit into said franking machine.

39. An arrangement as claimed in claim 22 wherein said data processing unit and said data center exchange information in said transaction and, in said implementation step, said data center protocols at least a portion of said information and from said protocoling generates an item of protocol information.

40. An arrangement as claimed in claim 39 wherein said data center transmits at least a portion of said item of protocol information to said second source as a report.

41. An arrangement as claimed in claim 22 wherein said data center and said data processing unit, in said implementation step, exchange information between said data processing unit and said data center and secure said information using at least one procedure selected from the group consisting of encrypting said information and authenticating said information.

42. An arrangement as claimed in claim 22 comprising:
a plurality of data processing units, forming a group of data processing units including said data processing unit;
said data center implements said transaction between any of said data processing units in said group and said data center; and
said second source provides a group item of transaction control information associated with said group, as said second item of transaction control information.

43. A data center for implementing a transaction between the data center and a data processing unit remote therefrom via a communication link, said data center comprising:
a first memory containing a first item of transaction control information, provided by a first source and associated with said data processing unit;
a second memory containing a second item of transaction control information, provided by a second source and associated with said data processing unit; and
a transaction implementation arrangement that implements said transaction with said data processing unit via said communication link dependent on said first and second items of transaction control information.
